(19) United States
(12) Patent Application Publication
(10) Pub. No.: US 2008/0191471 A1
(43) Pub. Date: Aug. 14, 2008

(54) Plug-In Connection Provided With an Angle-Locking Device

(75) Inventor: Harald Hartmann, Dornbirn (AT)

Correspondence Address: NORRIS, MCLAUGHLIN & MARCUS, 875 THIRD AVE, 18TH FLOOR, NEW YORK, NY, 10022, US

(73) Assignee: HENN GMBH CO. KG, Dornbirn (AT)

(21) Appl. No.: 11/547,052

(22) PCT Filed: Mar. 31, 2005
(86) PCT No.: PCT/EP05/03393

§ 371 Date: Nov. 19, 2007

(30) Foreign Application Priority Data
Apr. 3, 2004 (DE) 10 2004 016 599.8

(51) Int. Cl. F16L 37/088

(52) U.S. Cl. 285/231

(57) ABSTRACT

The invention relates to a plug-in connection provided with an angle-locking device for connecting tubular pipes and flexible hoses. The aim of said invention is to improve the design of a said type plug-in connection in such a way that it is possible to produce the angular locking device by particularly simple means, thereby avoiding any risk of an accident during operation of the plug-in connection, and to embodied said connection optionally with or without angular locking device without important transformation expenditures. The inventive connection is, therefore characterised in that it comprises a pipe insertable into internal space of a plug-in part which is provided, on the front-surface side thereof in a plugging.

The invention relates to a plug-in connection with angle-position locking according to the preamble of claim 1.

A plug-in connection which includes an installation aid is described in the patent application DE 102 311 114 by the same applicant, with the aim to enable a connection between a plug section and a connection piece with a defined angle.

For manufacturing an angle-position lock for the plug-in connection disclosed in DE 102 311 114, separate, radially outwardly extending components, which are secured to the outer sleeve, must be attached on the plug section. These components engage in a corresponding retaining section on the connection piece when the plug-in connection is established (when the plug section is inserted axially into the connection piece), so as to enable a plug-in connection with a defined angle.

However, the fabrication of such angle-position lock is extremely complex and increases the overall manufacturing costs of the plug-in connection. In addition, there is a risk that components which are separately installed on the plug section can fall off or are incorrectly attached, which causes additional uncertainty in their operation.

It is also known to arrange detents on the plug section which are inserted into a groove on the connection piece. However, two different embodiments of the plug will then have to be manufactured, if an angle-position lock is not desired with certain plug-in connections, namely on one hand with attached detents and, the other hand, without these detents. However, a plug-in connection that can be used universally, i.e., selectively with and without an angle-position lock, cannot be readily manufactured.

It is also known to provide connection pieces which are inserted into the interior space of the plug section with a protuberance, which is inserted into a groove arranged on the plug. However, such connection piece is difficult to implement with many manufacturing processes.

It is also known to arrange so-called pegs along the outer periphery of the connection piece and corresponding notches along the outer periphery of the plug section. However, the outer periphery of the section may disadvantageously be handled manually during manufacture of the plug-in connection, which poses the risk of injury. The notches disposed along the outer periphery of the plug component have typically sharp edges, which may cause cuts when the plug connection is established, because a user's hand can come in contact with these notches.

It is therefore an object of the invention to improve a plug-in connection of the aforedescribed type by providing a simple angle-position lock which reduces the risk of injury when handling the plug-in connection, and by manufacturing the plug-in connection so that it can be selectively used either with or without angle-position locking, without necessitating costly changes in the manufacturing process.

The object of the invention is characterized by the technical teachings of claim 1. The plug-in connection of the invention is based on a design where the connection piece is inserted in the interior part of the plug section. As an important feature of the invention, the front face of the connection piece, as viewed in the plug-in direction, includes axially oriented guide openings, which are open in the axial direction. Moreover, several guide projections which are axially spaced from the snap-in connection and extend radially inward into the unobstructed plug opening, are arranged on the plug section.

With the aforedescribed technical teachings, such guide projections can now particularly easily manufactured.

If the plug section is viewed as a can with a closed bottom, then the guide projections would be arranged in the region of the bottom.

The guide projections are fabricated by simply punching the bottom of the inner sleeve so that the guide projections remain in place. This represents a particularly simple manufacturing process, with the guide projections extending into the unobstructed width of the plug opening of the plug section. This also eliminates the risk for injury, because the outer periphery of the plug section no longer includes notches, protuberances or other protruding elements which can cause injury.

The connection piece can also be fabricated in a very simple manner, because it is sufficient to arrange several guide openings in the region of the front end face, which cooperate with the guide projections on the plug section that project into the unobstructed width of the plug opening.

It is important when establishing the plug-in connection that the guide projections arranged on the plug section at least partially engage with the guide openings on the connection piece, before the plug-in connection between the plug section and the connection piece is actually established.

This ensures that the plug-in connection is installed with a defined angle position.

Since the “bottom” of the plug section is punched in form of a contour and furthermore punched out so that only the radially inwardly pointing guide projections remain, differently shaped projections can also be very easily punched out. Some projections can be made larger and others can be made smaller, with the corresponding guide openings on the connection piece being adapted accordingly, so as to enable insertion of the plug-in connection with a defined angle position.

If all guide projections and likewise also all guide openings in the connection piece are formed identically, then the plug-in connection can be plugged together with any angle position, provided that the guide projections disposed on the plug section engage with the guide openings on the connection piece. The plug-in connection can only be plugged together, for example, with angular positions of 45, 60 or 90°.

Advantageously, such plug-in connection can be readily converted from a lock with a defined angle position to a lock without a defined angle position. This can be accomplished by bending the guide projections away from the unobstructed width of the plug opening, so that the plug-in connection can be connected with an arbitrary angle position. Alternatively, the guide projections may be left in place while simultaneously reducing the length of the connection piece near the front end face in the axial direction, so as to essentially produce a continuous peripheral open guide opening, which then no longer provides a guiding function for the opposite projections.

Because only a specially contoured punching tool is required to punch a bottom, no additional tooling or machining is required for producing the angle-position lock.

The plug section can then always be implemented in the same way, regardless if a lock is employed or not. This depends only on the connection piece, as described above.

As also disclosed in DE 102 311 114, the angular play of the angle-position lock can also be readily defined when machining the tolerance of the guide openings on the connection piece. If according to the invention only the plug is to be manufactured, then the insertion length and the insertion taper (taper of the insertion bevel) can be defined by the respective manufacturer of the connection piece.

The connection piece with the applied guide openings can be manufactured quite easily, so that an angle-position lock can be embodied with a large number of suiatble materials without adding complexity. The connection piece can therefore be made of metal (sheet metal or cast metal), plastic or a metal-plastic composite.

The invention will be described hereinafter with reference to drawings which depict an exemplary embodiment. Additional features and advantages of the invention will be apparent from the drawings and their description.

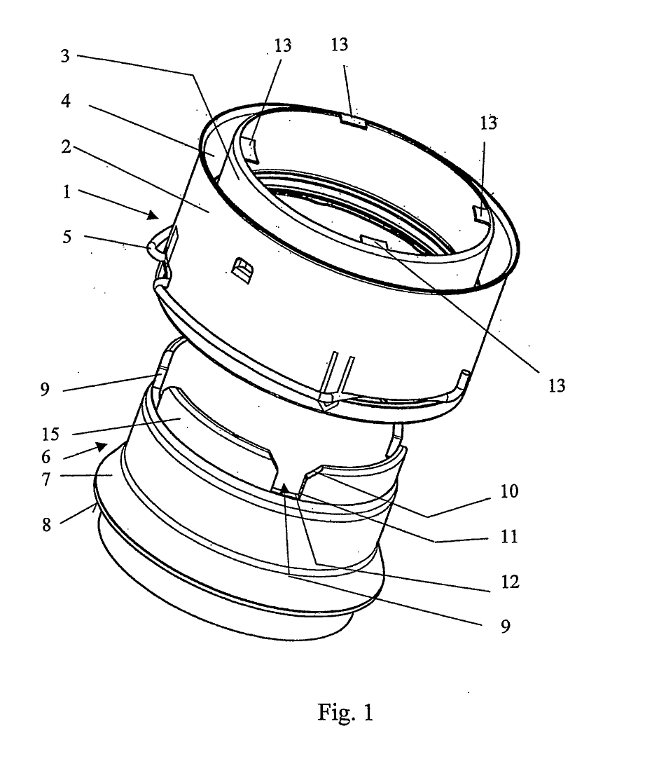

FIG. 1 shows a perspective view of the plug-in connection with angle-position lock in a disconnected configuration;

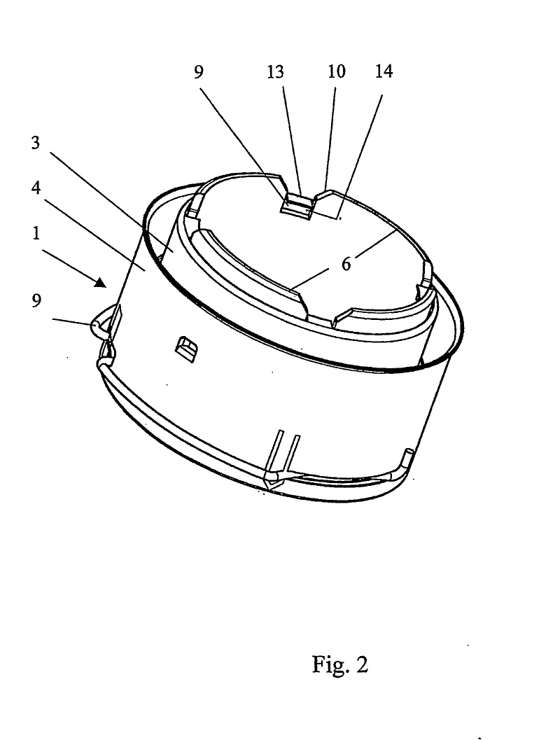

FIG. 2 shows the locked plug-in connection of FIG. 1.

As illustrated in FIG. 1, a plug section 1 is made of an outer sleeve 2 and a connected inner sleeve 3, which are made of the same material as one piece. However, the invention is not limited to this embodiment, as the plug section can be implemented in any other shape or form, for example, by entirely omitting the outer sleeve 2.

A continuous annular receiving space 4 is provided in the intermediate space between the outer sleeve 2 and the inner sleeve 3. A hose end can be inserted in the receiving space 4 in the axial direction and sealingly secured.

According to the invention, the plug section can also be formed as a single piece and of the same material as the connected hose.

For establishing the locking connection, the front portion of the plug section 1 has a catch spring 5 with several bent sections that project into the unobstructed width of the plug section 1.

A connection piece 6 can be inserted in the interior space of the plug section 1. The front end of the connection piece 6 has several guide openings 9 arranged along the periphery in the region of an annular collar 15.

Each guide opening 9 is open to the front in the axial direction where it is bordered by beveled insertion tapers 10, which merge into axially parallel guide edges 11, which in turn are closed off in the vertical direction by an abutting bottom surface 12.

The locking connection on the side of the connection piece consists of a radially outwardly oriented peripheral tapered catch 7 disposed on the sleeve of the connection piece 6 and forming a steep catch edge 8.

It is important that guide projections 13 are formed in the “bottom section” of the plug section 1 (in the present exemplary embodiment in the region of the inner sleeve 3) which point radially inwardly into the plug opening. The guide projections 13 are connected as one piece with the material of the inner sleeve 3 and are, as described above, formed by contour-punching from the existing bottom of the inner sleeve 3.

The plug-in connection is established by inserting the connection piece 6 in the unobstructed width of the plug section 1, so that initially the guide projections 13 engage with the insertion tapers 10 on the connection piece 6. When this position is reached, angular rotation between the connection piece 6 and the plug section 1 is no longer possible. When the guide projections 13 are inserted farther in the axial direction, they engage in the region of the guide edges 11 with the tighter tolerance, whereafter the catch spring 9 disposed on the plug section 1 catches the locking edge 8 on the connection piece 6, thereby maintaining the angle-position lock as shown in FIG. 2.

FIG. 2 shows a relative tight tolerance of the angle-position lock, i.e., the length of the projections 13 along the periphery is approximately equal to the spacing between the guide edges 11. However, the clearance in this region may also be greater.

It can also be seen that the guide projections 13 have an additional unobstructed space 14 extending to the bottom surface 12 of the guide opening 9 in the axial direction, so as to provide the plug-in connection with a certain excess travel. With this approach, the user will be assured that the plug-in connection catches beyond its locking position, as determined by the unobstructed space 14.

If the angle-position lock is to be omitted, then the annular collar 15 may be entirely removed in a first embodiment, so that the entire guide opening 9 extends uninterrupted along the periphery.

In another embodiment, the guide projections 13 may be bent backwards in the axial direction with pliers, thus likewise preventing them from engaging with the guide openings 9 on the connection piece 6.

Moreover, a certain guide play in the guide openings 9 can be adjusted by bending the projections 13 in the axial direction. Finally, the guide projections 13 can also be beveled with a suitable tool which increases the play for the angular rotation in the guide opening 9.

The guide projections can also be bent in the axial direction toward the unobstructed width of the plug opening, until they springily contact the bottom surface 12 and bridge the unobstructed space 14. This approach provides a plug-in connection between the connection piece 6 and the plug section 1 which is spring-biased in the opening direction.

Figure Legend

1 Plug section

2 Outer sleeve

3 Inner sleeve

4 Receiving space

5 Catch spring

6 Connection piece

7 Tapered catch

8 Locking edge

9 Guide opening

10 Insertion taper

11 Guide edge

12 Bottom surface

13 Guide projections

14 Unobstructed space

15 Annular collar

1. Plug-in connection with angle-position locking for connecting pipe and hose connections, comprising a plug section, to which the pipe and hose connection is connected, wherein a movable guide which operates in the axial direction and secures against rotation in the circumferential direction is arranged between the plug section and the connection piece, the movable guide comprising guide projections which are distributed along the front face of the plug section and operate in the axial direction, wherein the guide projections cooperate with corresponding recesses disposed on the opposite part, with the recesses being formed directly on the exterior periphery of the opposite part as an installation aid for securing the plug-in connection against the effect from an applied torque, and that the installation aid only permits a certain rotation position between the parts to be plugged together, wherein the connection piece to be plugged in the interior space of the plug section includes axially oriented guide openings disposed on the front face in the plug-in direction, as viewed in the plug-in direction, which are open in the axial direction, and several guide projections projecting radially inwardly into the unobstructed plug opening are arranged on the plug section with an axial spacing from the latching connection.

2. Plug-in connection according to claim 1, wherein the guide projections are formed by punching out the bottom material on the plug section, wherein the guide projections are formed from the remaining material.

3. Plug-in connection according to claims 1, wherein the surface at the outer periphery of the plug section is formed as a smooth surface.

4. Plug-in connection according to claims 1, wherein the guide projections on the plug section are arranged so as to at least in partially engage with the guide openings on the connection piece.

5. Plug-in connection according to claims 1, wherein the plug-in connection with the guide projections, which at least partially engage in the guide openings, forms a mechanism that limits angular rotation

6. Plug-in connection according to claims 1, wherein bottom of the plug section to be punched out, which also forms the radially inwardly oriented guide projections, has material removed in the form of a punched contour.

7. Plug-in connection according to claims 1, wherein the guide projections formed from the bottom of the plug section are differently shaped and have different dimensions.

8. Plug-in connection according to claims 1, wherein the guide projections formed from the bottom of the plug section are identically shaped and have identical dimensions.

9. Plug-in connection according to claims 1, wherein the guide openings in the connection piece are formed according to the shape and dimension of the guide projections in the plug section.

10. Plug-in connection according to claims 1, wherein the plug-in connection with identically formed guide projections on the plug section and corresponding identically formed guide openings in the connection piece can be plugged together in an angular position of 45°, 60° or 90°.

11. Plug-in connection according to claims 1, wherein the plug-in connection comprises angle-independent locking.

12. Plug-in connection according to claims 1, wherein the plug-in connection with angle-independent locking includes guide projections which are bent away from the unobstructed width of the plug opening.

13. Plug-in connection according to claims 1, wherein the plug-in connection with angle-independent locking has an arbitrary rotation position.

14. Plug-in connection according to claims 1, wherein the connection piece is truncated in the axial direction around the area at the front end face.

15. Plug-in connection according to claims 1, wherein the truncated connection piece includes a peripheral open guide opening.

16. Plug-in connection according to claims 1, wherein the plug section has a universal configuration which can be employed for rotation-angle-limiting and rotation-angle-independent plug-in connections.

17. Plug-in connection according to claims 1, wherein the guide opening on the connection piece includes a certain play with respect to insertion length and insertion taper.
